(19) United States
(12) Patent Application Publication
(10) Pub. No.: US 2007/0162850 A1
(43) Pub. Date: Jul. 12, 2007

(54) Sports-related widgets

(76) Inventors: Darin Adler, Los Gatos, CA (US); Freddy A. Anzures, San Francisco, CA (US); Matthew Caprile, Campbell, CA (US); Gregory N. Christie, San Jose, CA (US); John O. Louch, San Luis Obispo, CA (US)

Correspondence Address: FISH & RICHARDSON P.C., PO BOX 1022, MINNEAPOLIS, MN, 55440-1022, US

(21) Appl. No.: 11/328,493

(22) Filed: Jan. 6, 2006

(51) Int. Cl. G06F 9/00

(52) U.S. Cl. 715/700; 715/764; 715/810; 715/835

(57) ABSTRACT

Systems, methods, computer-readable mediums, user interfaces and other implementations are disclosed for defining, installing, launching, managing, displaying and operating sports-related widgets in a display environment. The sports-related widgets can be configured to provide information related to sporting events.

### RELATED APPLICATIONS

The subject matter of this patent application is related to jointly owned and co-pending U.S. patent application Ser. No. 10/877,968, entitled “Unified Interest Layer For User Interface,” filed Jun. 25, 2004, and U.S. patent application Ser. No. 11/282,110, entitled “Preview Including Theme Based Installation of User Interface Elements In A Display Environment,” filed Nov. 16, 2005. Each of these patent applications is incorporated herein by reference in its entirety.

### TECHNICAL FIELD

The disclosed implementations relate generally to graphical user interfaces.

### BACKGROUND

A hallmark of modern graphical user interfaces is that they allow a large number of graphical objects or items to be displayed on a display screen at the same time. Leading personal computer operating systems, such as Apple Mac OS®, provide user interfaces in which a number of windows can be displayed, overlapped, resized, moved, configured, and reformatted according to the needs of the user or application. Taskbars, menus, virtual buttons and other user interface elements provide mechanisms for accessing and activating windows even when they are hidden behind other windows.

Although users appreciate interfaces that can present information on a screen via multiple windows, the result can be overwhelming. For example, users may find it difficult to navigate to a particular user interface element or to locate a desired element among a large number of onscreen elements. The problem is further compounded when user interfaces allow users to position elements in a desired arrangement, including overlapping, minimizing, maximizing, and the like. Although such flexibility may be useful to the user, it can result in a cluttered display screen. Having too many elements displayed on the screen can lead to “information overload,” thus inhibiting the user to efficiently use the computer equipment.

Many of the deficiencies of conventional user interfaces can be reduced using “widgets.” Generally, widgets are user interface elements that include information and one or more tools (e.g., applications) that let the user perform common tasks and provide fast access to information. Widgets can perform a variety of tasks, including without limitation, communicating with a remote server to provide information to the user (e.g., weather report), providing commonly needed functionality (e.g., a calculator), or acting as an information repository (e.g., a notebook). Widgets can be displayed and accessed through a user interface, such as a “dashboard layer,” which is also referred to as a “dashboard.” Widgets and dashboards are described in co-pending U.S. patent application Ser. No. 10/877,968, entitled “Unified Interest Layer For User Interface.”

The popularity of widgets has generated interest in developing new and improved widgets that are capable of providing useful information, performing various tasks or simply providing entertainment.

### SUMMARY

Systems, methods, computer-readable mediums, user interfaces and other implementations are disclosed for defining, installing, launching, managing, displaying and operating sports-related widgets in a display environment.

In some implementations, a method of presenting sports-related information includes: displaying a dashboard layer including a sports-related widget; receiving a sport selection; aggregating information relating to the selected sport from one or more information sources; and configuring the widget to display at least some aggregated information.

In some implementations, a sports-related widget is configurable for display in a dashboard layer. The widget includes a selection mechanism for receiving a sport selection. The widget also includes an aggregator adapted for aggregating information relating to the selected sport from one or more information sources. A display area associated with the widget is adapted for displaying at least some aggregated information.

In some implementations, a system for presenting sports-related information includes a processor and a computer-readable medium coupled to the processor. The computer-readable medium includes instructions, which when executed by the processor, causes the processor to perform the operations of: displaying a dashboard layer including a sports-related widget; receiving a sport selection; aggregating information relating to the selected sport from one or more information sources; and configuring the widget to display at least some aggregated information.

In some implementations, a computer-readable medium includes instructions, which when executed by a processor, causes the processor to perform the operations of: displaying a dashboard layer including a sports-related widget; receiving a sport selection; aggregating information relating to the selected sport from one or more information sources; and configuring the widget to display at least some aggregated information.

Other implementations are disclosed which are directed to systems, methods, computer-readable mediums and user interfaces.

### BRIEF DESCRIPTION OF THE DRAWINGS

FIG. 1 is a block diagram of a hardware architecture for implementing dashboards.

FIG. 2 is a flow diagram of a process for activating and using a dashboard.

FIG. 3 is a block diagram of a software architecture for implementing dashboards.

FIG. 4A is a screen shot depicting a desktop user interface prior to activation of a dashboard.

FIG. 4B is a screen shot depicting an initial state for a dashboard.

FIG. 4C is a screen shot depicting a configuration bar for a dashboard.

FIG. 4D is a screen shot depicting user selection of a widget from the configuration bar.

FIG. 5A is a screen shot of one implementation of a first view of a sports widget.

FIG. 5B is a screen shot of the first view of the sports widget with an expanded list.

FIG. 5C is a screen shot of a second view of a sports widget in news mode.

FIG. 5D is a screen shot of a second view of a sports widget in scores mode.

FIG. 5E is a screen shot of a second view of a sports widget in news mode when there is no news.

FIG. 5F is a screen shot of a second view of a sports widget in scores mode when there are no scores.

### DETAILED DESCRIPTION

### Hardware Architecture

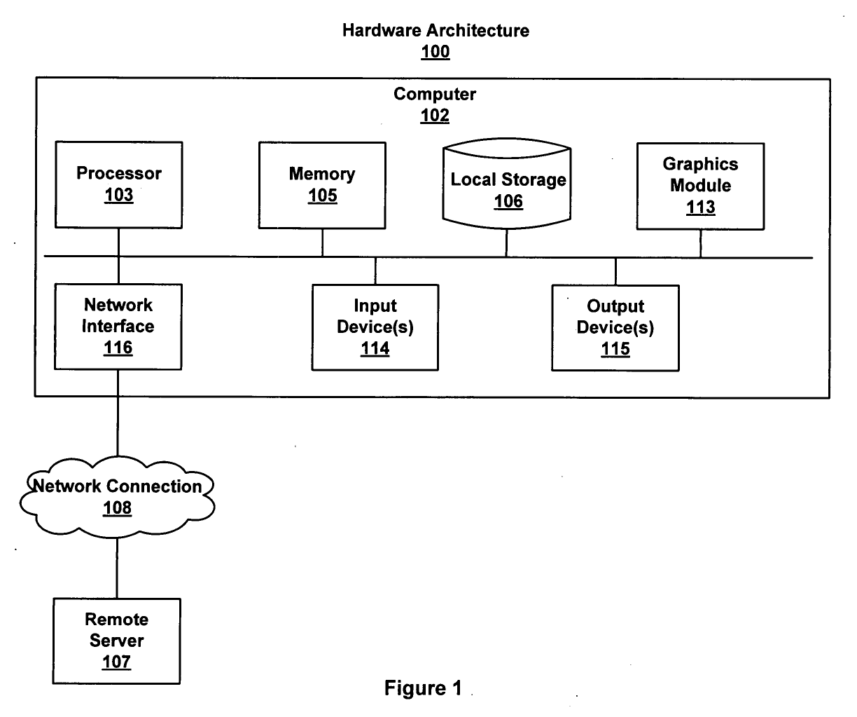

FIG. 1 is a block diagram of a hardware architecture 100 for implementing sports-related widgets. The architecture 100 includes a personal computer 102 coupled to a remote server 107 via a network interface 116 and a network connection 108 (e.g., local area network, wireless network, Internet, intranet, etc.). The computer 102 generally includes a processor 103, memory 105, one or more input devices 114 (e.g., keyboard, mouse, etc.) and one or more output devices 115 (e.g., a display device). A user interacts with the architecture 100 via the input and output devices 114, 115.

The computer 102 also includes a local storage device 106 and a graphics module 113 (e.g., graphics card) for storing information and generating graphical objects, respectively. The local storage device 106 can be a computer-readable medium. The term “computer-readable medium” refers to any medium that participates in providing instructions to a processor for execution, including without limitation, non-volatile media (e.g., optical or magnetic disks), volatile media (e.g., memory) and transmission media. Transmission media includes, without limitation, coaxial cables, copper wire, fiber optics, and computer buses. Transmission media can also take the form of acoustic, light or radio frequency waves.

While widgets and dashboards are described herein with respect to a personal computer 102, it should be apparent that the disclosed implementations can be incorporated in, or integrated with, any electronic device that is capable of using widgets, including without limitation, portable and desktop computers, servers, electronics, media players, game devices, mobile phones, email devices, personal digital assistants (PDAs), televisions, etc.

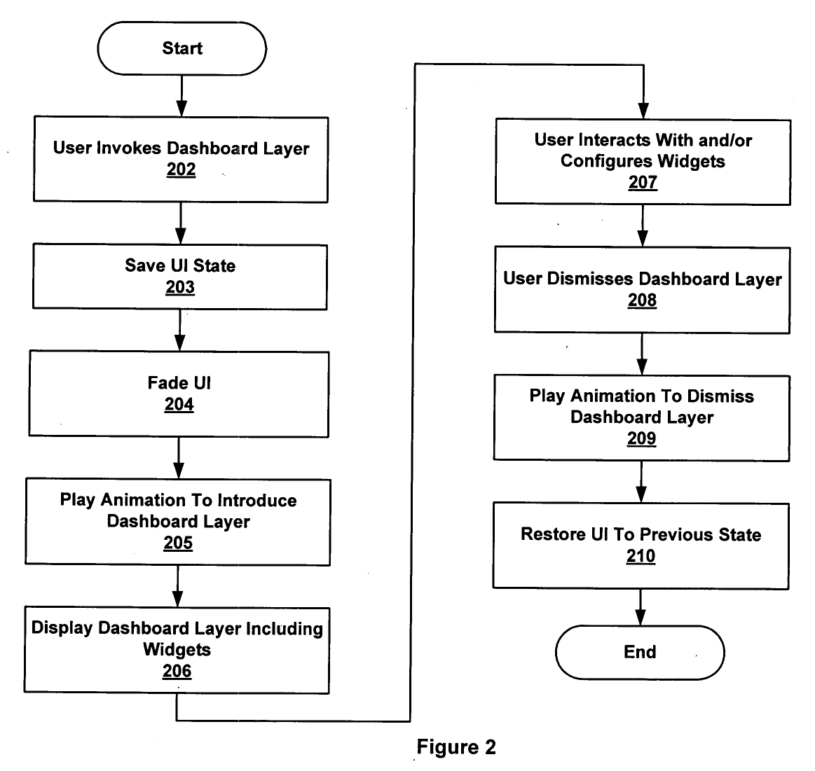

A dashboard system and method for managing and displaying dashboards and sports-related widgets can be implemented as one or more plug-ins that are installed and run on the personal computer 102. The plug-ins are configured to interact with an operating system (e.g., MAC OS® X, WINDOWS XP, LINUX, etc.) and to perform the various dashboard and widget functions, as described with respect of FIGS. 2-8. A dashboard system and method can also be implemented as one or more software applications running on the computer 102. In some implementations, a dashboard system can be another widget that is configurable to communicate with other widgets, applications and/or operating systems. A dashboard system and method can also be characterized as a framework or model that can be implemented on various platforms and/or networks (e.g., client/server networks, stand-alone computers, portable electronic devices, mobile phones, etc.), and/or embedded or bundled with one or more software applications (e.g., email, media player, browser, etc.).

For illustrative purposes, widgets (including sports-related widgets) are described as a feature of an operating system. Widgets, however, can be implemented in other contexts as well, including e-mail environments, desktop environments, application environments, hand-held display environments, and any other display environments.

### Dashboard Overview

FIG. 2 is a flow diagram of an implementation of a process for activating and using one or more dashboard layers. A dashboard layer (also referred to herein as a “unified interest layer” or “dashboard”) is used to manage and display widgets (including linked widgets). A user can invoke a dashboard (202) by hitting a designated function key or key combination, by clicking on an icon, by selecting a command from an onscreen menu, or by moving an onscreen cursor to a designated corner of the screen. Alternatively, a dashboard layer can be invoked programmatically by another system, such as an application or an operating system, etc.

In response to such user input, the current state of the user interface is saved (203), the user interface is temporarily inactivated (204), an animation or effect is played or presented to introduce the dashboard (205) and the dashboard is displayed with one or more widgets (206). If applicable, a previous state of the dashboard is retrieved, so that the dashboard can be displayed in its previous configuration.

In some implementations, the dashboard is overlaid on an existing user interface (UI) (e.g., a desktop UI). When the dashboard is activated, the existing UI may be faded, darkened, brightened, blurred, distorted, or otherwise altered to emphasize that it is temporarily inactivated. The existing UI may or may not be visible behind the dashboard. The UI can also be shrunk to a small portion of the display screen while the dashboard is active, and can be re-activated by clicking on it. In some implementations, the UI is shrunk and presented as a widget. The UI can be re-activated by clicking on the widget. In some implementations the UI remains active when the dashboard is active.

The user interacts with and/or configures widgets as desired (207). In some implementations, the user can move widgets around the screen, and can resize widgets if applicable. Some widgets are resizable and some have a fixed size. A widget author can specify whether a widget can be resized. Some widgets automatically resize themselves based on the amount or nature of the data being displayed. Widgets can overlap and or repel one another. For example, if the user attempts to move one widget to a screen position occupied by another widget, one of the widgets is automatically moved out of the way or repelled by the other widget.

In some implementations, the user dismisses the dashboard (208) by invoking a dismissal command, which causes the UI layer to return or represent itself to the display screen. In some implementations, the dashboard is dismissed when the user presses a function key or key combination (which may be the same or different than the key or combination used to activate the dashboard), or clicks on a close box or other icon, or clicks on negative space within the dashboard (e.g., a space between widgets), or moves an onscreen cursor to a predefined corner of the screen.

In some implementations, the dashboard is automatically dismissed (i.e., without user input) after some predetermined period of time or in response to a trigger event. An animation or other effect can be played or presented to provide a transition as the dashboard is dismissed (209). When the dashboard is dismissed, the current configuration or state of the widgets (e.g., position, size, etc.) is stored, so that it can be retrieved the next time the dashboard is activated. In some implementations, an animation or effect is played or presented when re-introducing the UI. The UI is restored to its previous state (210) so that the user can resume interaction with software applications and/or the operating system.

In some implementations, the dashboard is configurable. The user can select a number of widgets to be displayed, for example, by dragging the widgets from a configuration bar (or other user interface element) onto the dashboard. The configuration bar can include different types of widgets, and can be categorized and/or hierarchically organized. In some implementations, in response to the user dragging a widget onto the configuration bar, the widget is downloaded from a server and automatically installed (if not previously installed). In some implementations, certain widgets can be purchased, so the user is requested to provide a credit card number or some other form of payment before the widget is installed on the user's machine. In some implementations, widgets are already installed on the user's machine, but are only made visible when they have been dragged from the configuration bar onto the dashboard. The configuration bar is merely an example of one type of UI element for configuring the dashboard. Other configuration mechanisms can be used, such as an icon tray or menu system.

It should be apparent that there are many ways in which dashboards and widgets can be displayed other than those implementations described herein. For example, widgets can be displayed on any user interface or user interface element, including but not limited to desktops, browser or application windows, menu systems, trays, multi-touch sensitive displays and other widgets.

### Software Architecture

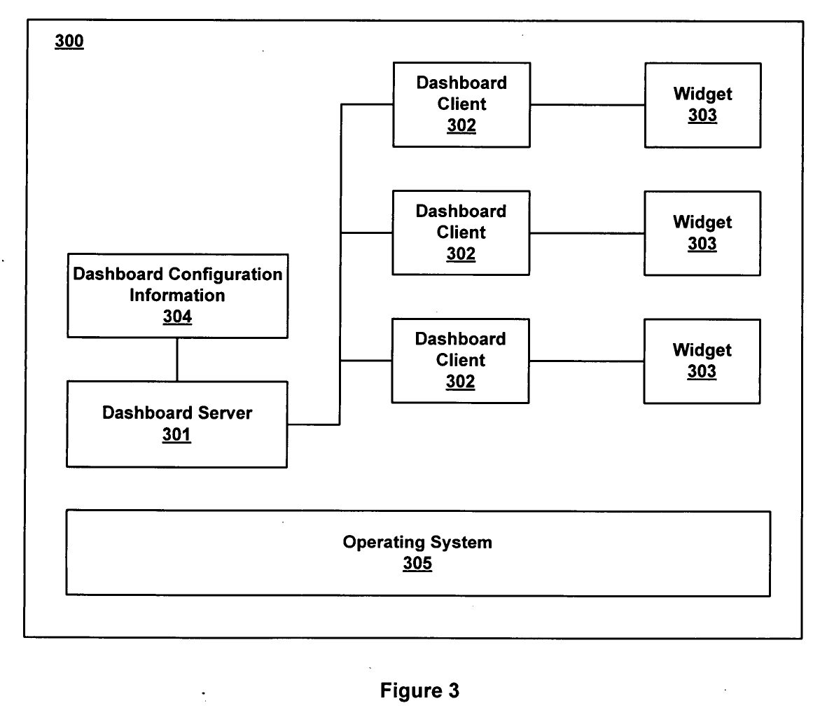

FIG. 3 is a block diagram of a software architecture 300 for implementing dashboards for installing, displaying and launching linked widgets. The software architecture 300 generally includes a dashboard server 301, one or more dashboard clients 302, and one or more widgets 303. The server 301 and/or clients 302 use dashboard configuration information 304 to specify configuration options for displaying the widgets 303, including access levels and the like (if applicable). Such configuration information can include information for two or more dashboards configured by the same user or by different users.

In some implementations, the widgets 303 are displayed using HTML and related web technology. The dashboard server 301 manages and launches the dashboard client 302 processes. Each dashboard client 302 loads a widget 303 (e.g., an HTML webpage) and related resources needed to display the page. In some implementations, the dashboard clients 302 display the widgets 303 without a conventional window frame, menu bar, or other components typically associated with on-screen windows. This technique provides a clean, straightforward display of the overall dashboard to reduce confusion and clutter.

The dashboard clients 302 display their respective widgets 303 by rendering web pages into a “WebView,” as described in U.S. patent application Ser. No. 10/877,968, entitled “Unified Interest Layer For User Interface.” The size of each WebView is defined as metadata associated with the corresponding widget 303. The server 301 provides data for rendering the dashboard layer that can be overlaid on a desktop user interface. In some implementations, the widgets 303 are rendered into the dashboard layer, which is drawn on top of the desktop user interface, so as to partially or completely obscure the desktop user interface while the dashboard layer is active.

### Dashboard Server

The dashboard server 301 can be a stand-alone process or embedded in another process. The server 301 can be located at the computer 102 or at the remote server 107. In some implementations, the server 301 provides functionality for one or more processes, including but not limited to: non-widget UI management, window management, fast login, event management, loading widgets, widget arbitration, Core Image integration and widget preference management, as described in U.S. patent application Ser. No. 10/877,968, entitled “Unified Interest Layer For User Interface.”

### Dashboard Client

In some implementations, a dashboard client 302 is a process that uses, for example, objects that are defined as part of a development environment, such as Apple Computer's Cocoa Application Framework (also referred to as the Application Kit, or AppKit) for the Mac OS® operating system. In some implementations, the dashboard clients 302 can be implemented as simplified browser screens that omit conventional interface features such as a menu bar, window frame, and the like.

### Widget Format

In one implementation, each widget 303 is implemented as an HTML file. The HTML file can reference other local and remote resources such as style sheets (e.g., Cascading Style Sheets), other HTML files, JavaScript files, images, and the like. Widgets 303 can be implemented using, for example, a flat bundle file format or a packaged HTML file format. In some implementations, the Flat Bundle format includes an info.plist file.

The Info.plist files describes a widget 303 and provides an identifier for a widget 303. Table I provides an example of Info.plist file contents.

TABLE I
Example of Info.plist File Contents

| Key | Type | Description/Value |
|---|---|---|
| CFBundledentifier | CFString | com.apple.widget |
| | | <widget name> |
| CFBundleName | CFString | Name of the widget. |
| MainHTML | CFString | Name of main HTML |
| | | resource. |
| Width | CFNumber | Default width of the |
| | | widget. |
| Height | CFNumber | Default height of the |
| | | widget. |
| DefaultImage | CFString | Resource name of |
| | | default PNG file. |
| Plugin (optional) | CFString | Resource name of |
| | | native plug-in. |
| AllowFileAccessOutsideofWidget | Boolean | Access to files across |
| | | the file system; limited |
| | | by the users |
| | | permissions. |
| AllowFullAcess | Boolean | Access to the file |
| | | system, Web Kit and |
| | | standard browser |
| | | plug-ins, Java applets, |
| | | network resources, |
| | | and command-line |
| | | utilities. |
| AllowsInternetPlugins | Boolean | Access to Web Kit and |
| | | standard browser |
| | | plug-ins. |
| AllowJava | Boolean | Access to Java applets. |
| AllowNetworkAccess | Boolean | Access to any |
| | | resources that are not |
| | | file based. |
| AllowSystem | Boolean | Access to command- |
| | | line utilities using |
| | | widget script object. |

The keys AllowFileAccessOutsideofWidget, AllowFullAccess AllowInternetPlugins, AllowJava, AllowNetworkAccess, and AllowSystem are Boolean types that can be set by a widget author to enable certain levels of resource access.

### Dashboard Invocation

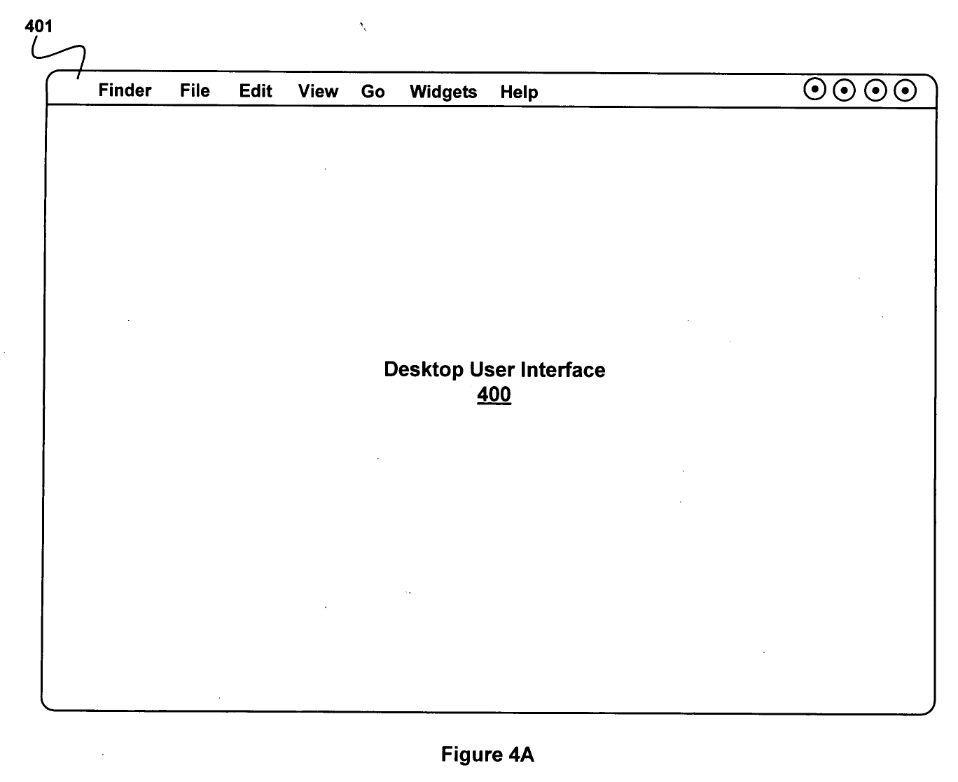

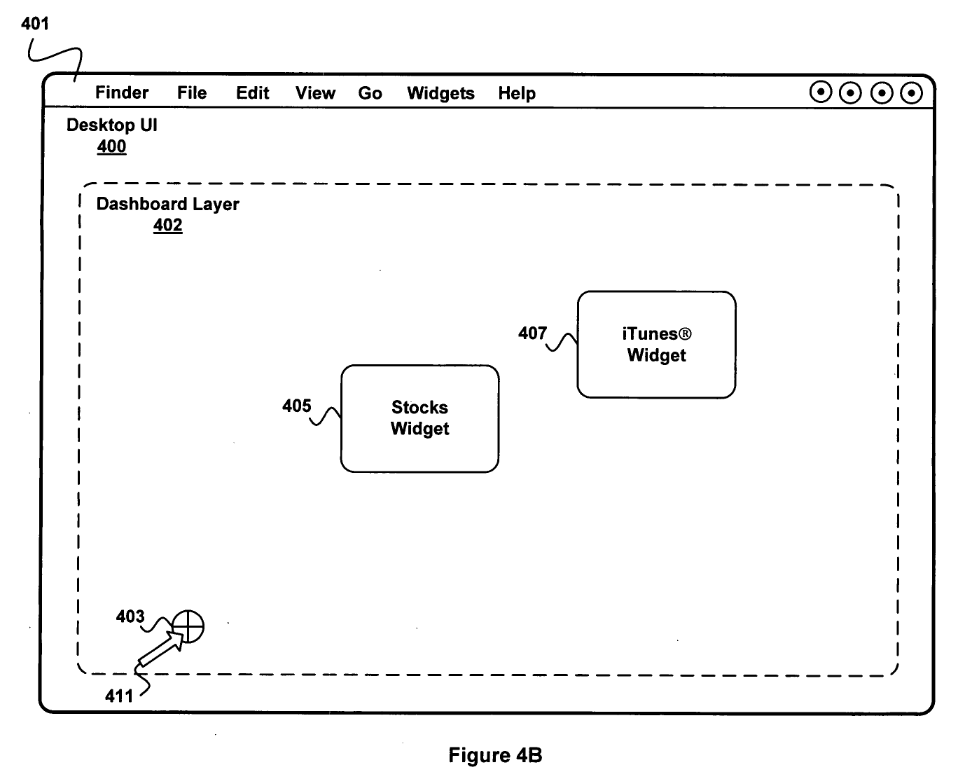

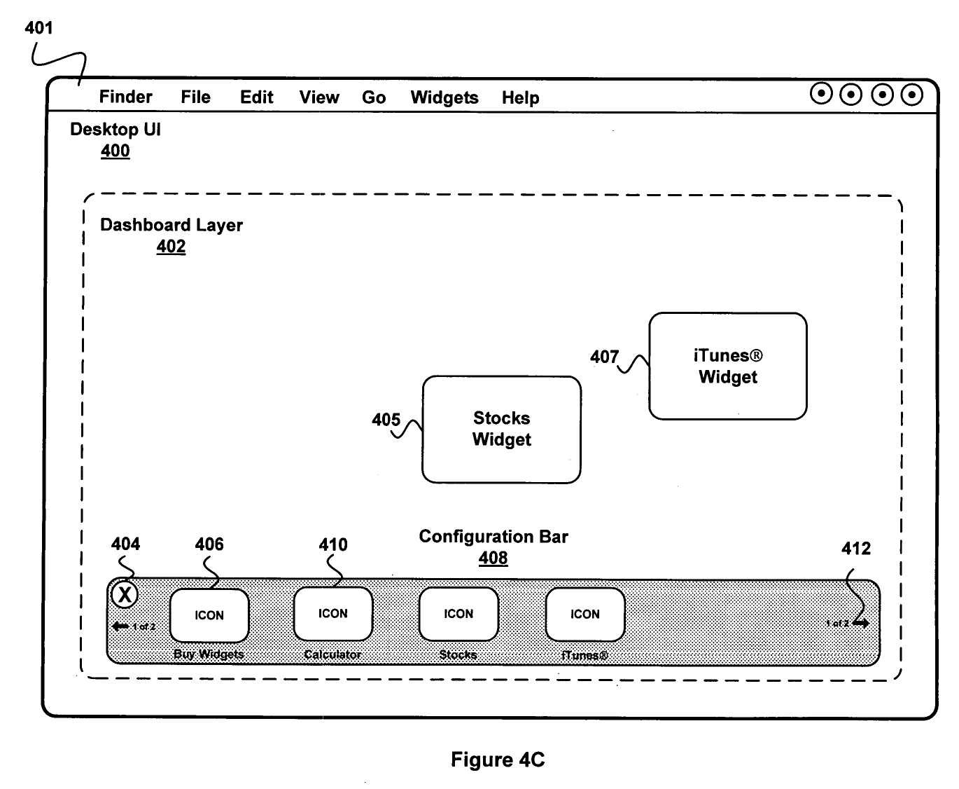

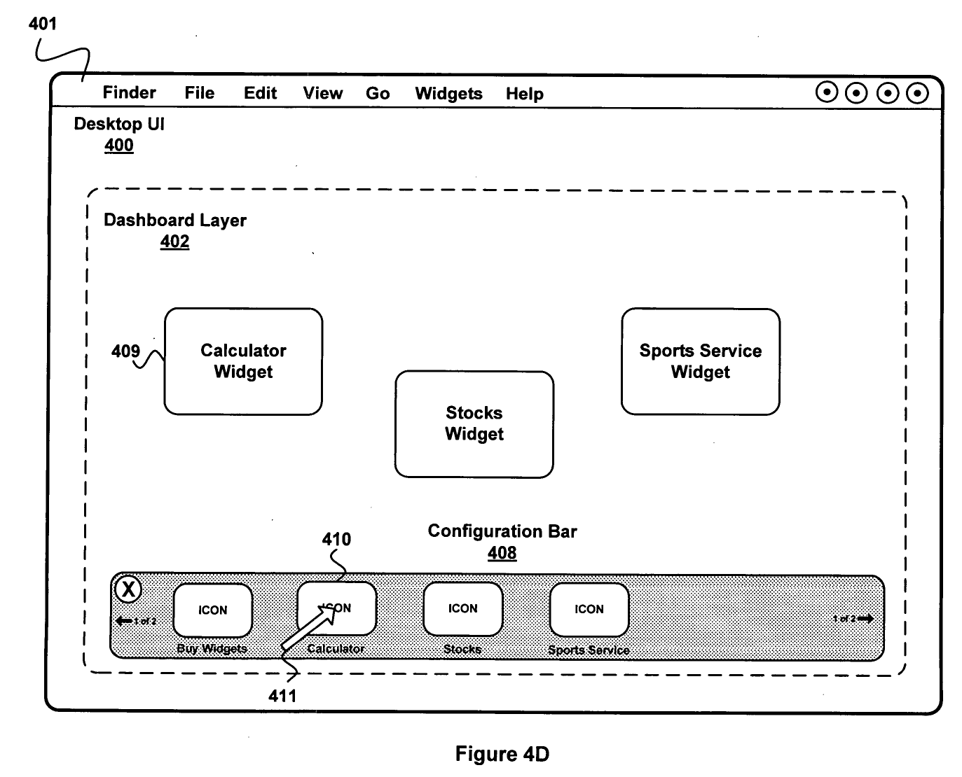

FIG. 4A depicts a desktop user interface 400 prior to activation of a dashboard. The desktop user interface 400 (also referred to herein as “desktop”) is a conventional user interface as may be provided by an operating system, such as Mac OS®. The desktop 400 has a background image, menu bar 401, and other standard features. As is known in the art, the desktop 400 may also include windows, icons, and other elements (not shown). The user activates the dashboard by selecting an item from a menu, or by clicking on an icon, or by pressing a function key or key combination, or by some other means for invoking activation. A dashboard does not have to be activated on a desktop; rather the dashboard can be activated and displayed on any display screen with or without a desktop.

FIG. 4B depicts an initial state for a dashboard layer 402. In some implementations, a configuration bar icon 403 is initially displayed. Alternatively, upon activation the dashboard layer 402 can display one or more default widgets 405, 407. If the dashboard layer 402 has previously been activated and configured, the widgets 405, 407, can be displayed as previously configured. The dashboard layer 402 is not necessarily visible as a distinct layer. However, its various components (such as widgets, icons, and other features) are visible. In some implementations, these components are displayed in a transparent layer, thus maintaining the visibility of the desktop 400 to the user. In some implementations, the desktop 400 and its components are darkened (or blurred, or otherwise visually modified) while the dashboard layer 402 is active, so as to emphasize that the desktop 400 is temporarily inactive. In other implementations, the desktop 400 is not visible while the dashboard layer 402 is active. The user can reactivate the desktop 400 and dismiss the dashboard layer 402 by clicking on an area of the screen where no dashboard element is displayed (i.e., “negative space”). In some implementations, other commands, key combinations, icons, or other user input can be used to dismiss the dashboard layer 402.

In some implementations, the user can drag the icon 403 to any location on the screen, and the position of the icon 403 will remain persistent from one invocation of the dashboard layer 402 to the next. The user can click on the icon 403 to activate the configuration bar 408, as shown in FIG. 4C. The configuration bar 408 provides access to various widgets that can be placed on the dashboard. In some implementations, a text label is shown for each available widget (e.g., calculator, stocks, ESPN®, etc.). In some implementations, an icon is shown for each available widget (e.g., calculator icon 410). If many widgets are available, the widgets may be arranged hierarchically by type (e.g., game widgets, utility widgets, etc.), or alphabetically, or by any other categorization methodology. For example, a number of categories may be displayed, and clicking on one of the categories causes a pull-down menu to be displayed, listing a number of widgets in that category. In some implementations, a buy widget 406 is also available, allowing the user to select widgets from an online store or website.

Note that the particular configuration and appearance of configuration bar 408 in FIG. 4C is merely exemplary, and that many other arrangements are possible. For example, widgets can be installed from other locations, other applications or other environments, without requiring that they first be part of the configuration bar 408. The user can dismiss the configuration bar 408 by clicking on dismissal button or icon 404.

### Installation of Elements

Elements, including user interface elements such as widgets can be installed in a display environment as discussed below. One display environment, a dashboard, will be used for illustrative purposes. Installation can include a preview operation, as described in U.S. patent application Ser. No. 11/282,110, entitled “Preview Including Theme Based Installation of User Interface Elements In A Display Environment.” Installation can include selection of the element, such as by a drag and drop action. Other selection means can be used. In one example, a user can drag widgets from configuration bar 408 onto the surface of the dashboard (in other words, anywhere on the screen), using standard drag-and-drop functionality for moving objects on a screen.

FIG. 4D depicts the selection of the calculator widget icon 410 from the configuration bar 408. The calculator icon 410 which is associated with a calculator widget 409 is highlighted, or otherwise augmented or embellished, to indicate that it has been selected by a user with cursor 411.

In some implementations, widgets in the configuration bar 408 are smaller than their actual size when installed. When the user clicks on a widget and begins to drag it into a dashboard or other display environment, the widget is animated to its actual or installed size to assist the user in the real-time layout of the dashboard. By animating the widget to its actual size, the user will know the actual size of the widget prior to its installation.

In some implementations, an animation, such as a ripple animation, is shown when the user “drops” a widget by releasing a mouse button (or equivalent input device) to place a widget at the desired location. In one implementation, the dragging of the widget to the dashboard layer 402 invokes an installation process for installing the widget including previewing. After installation, the user can move a widget, to any other desired location, or can remove the widget from the screen, for example by dragging it off the screen, or dragging it back onto the configuration bar 408, by invoking a remove command, disabling a widget in a menu associated with a widget manager or canceling the installation during the. preview. In some implementations, the position, state, and configuration of a widget are preserved when the dashboard layer 402 is dismissed, so that these characteristics are restored the next time the dashboard layer 402 is activated.

In some implementations, widgets and/or dashboard layers (including widgets) can be installed from within a running application. For example, a widget and/or dashboard (including widgets) can be an attachment to an email. When the user clicks the attachment, an installation process is invoked for the widget and/or dashboard which can also include a preview.

Widgets can be created or instantiated using an installer process. The installer process can include a separate user interface or an integrated user interface (e.g., integrated in the display environment or separate from the display environment, for example, in another display environment associated with another application, such as an email application) for selecting and installing widgets in a display environment. For example, a widget received as an email attachment can be launched by a user from directly within a user interface of the email application.

Widgets can be created or instantiated using an installer process. The installer process can include a separate user interface or an integrated user interface (e.g., integrated in the display environment or separate from the display environment for example in another display environment associated with another application, such as an email application) for selecting and installing widgets in a display environment. Thus, the installation area for the widget can be embedded within an application display area or window. For example, if a user receives a widget as an attachment to an email, the user can invoke and install the widget from within the email message window without the need for a separate installation window.

In general, an installer process is used to provide additional functionality to the creation/instantiation process, beyond the simple drag and drop operation describe above. Additional functionality can include preview, security and deletion functionality in a singular interface. The installer process can be a separate process or combined in another process. The installer process can itself be a separate application that is executable to install widgets (or other elements) in a display environment. As used herein, the term “process” refers to a combination of functions that can be implemented in hardware, software, firmware or the like.

### Sports-Related Widgets

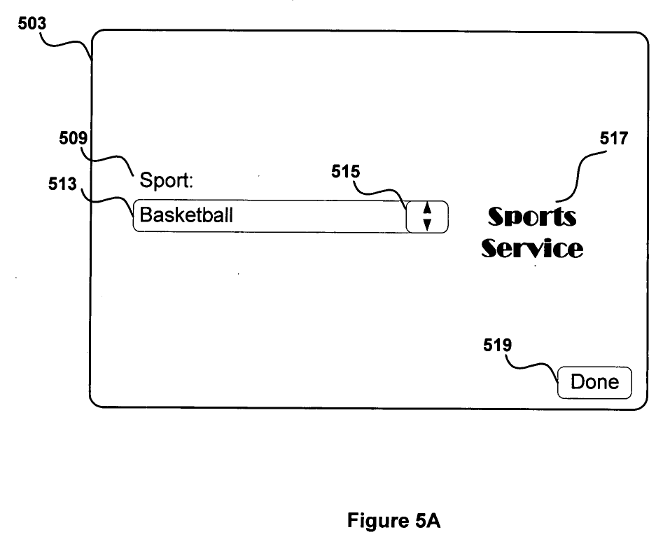

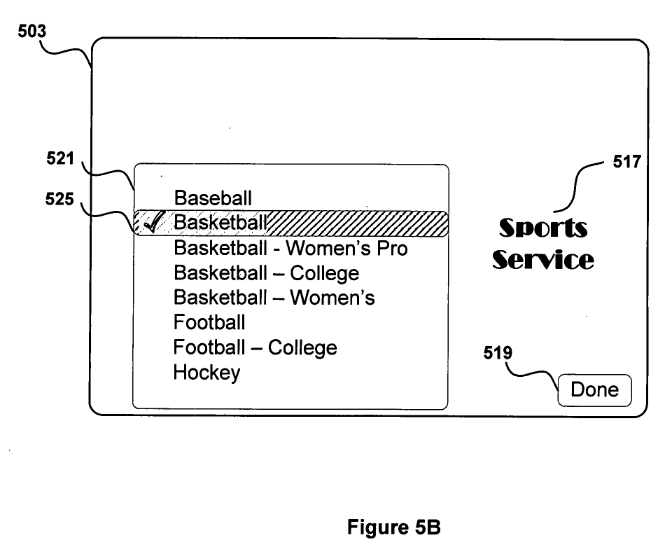

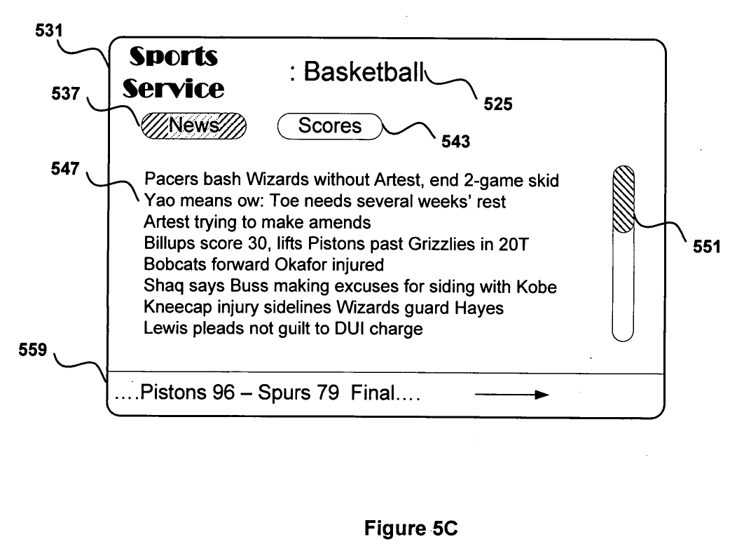

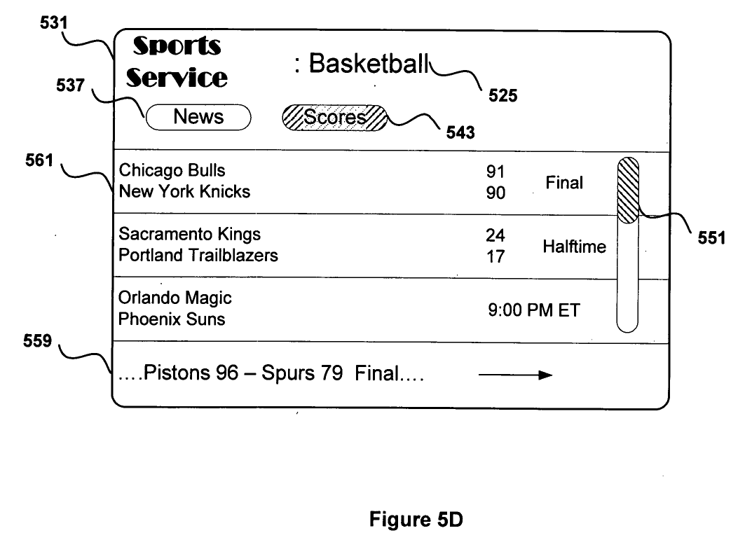

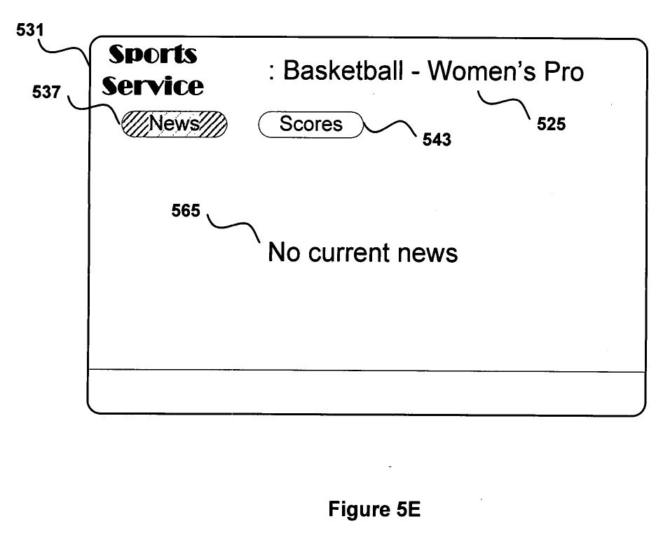

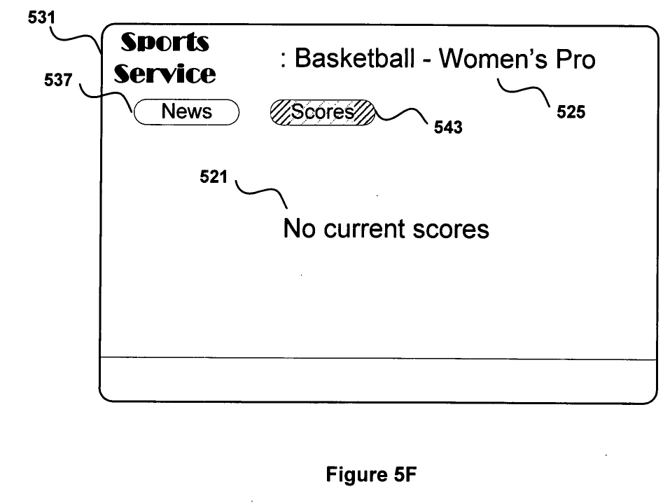

FIG. 5A is a screen shot of an implementation of a first view of a sports-related widget 503 (also referred to as a “sports widget”). In the first view of the sports widget 503, the user can select a sport 509 from a pull down menu 513. The sports widget 503 can include an indication 515, such as arrows, a plus sign or other such indication that other sports are available for selection in the pull down menu 513 or other selection mechanism. The first view of the sports widgets, along with other views, can display a logo 517 of a provider of the sports information. A logo for a fictitious service provider “Sports Service” is shown in FIG. 5A. In this example, an ESPN® logo is displayed, but the logo 517 can be of any sporting news provider. In some implementations, the menu 513 can provide further levels of user-selectable preferences (e.g., National versus American baseball leagues, college versus pro, domestic versus international, Pac-10, Big West, etc.).

FIG. 5B shows an expanded view of the list of types of sports 521 from which the user can select the desired sport. In some implementations, the selected sport 525 is indicated by shading, outlining, adding a symbol, changing the color or otherwise displaying the selected sport 525 differently from other choices on the list of types of sports 521. Once the user has chosen one of the listed sports, the user selects the done button 519. In some implementations, the user can save preferred sports widgets, so that in the future the user can bypass the step of selecting the sport that he or she wishes to view in the first view of the sports widget 503.

In some implementations, the widget is dedicated to multiple sports and the user does not need to select a sport in the first view of the widget 503. In some implementations, individual sports widget icons are selectable within a dashboard, such that the widget is dedicated to a single sport.

In some implementations, the sports widget 531 keeps track of the seasons and only displays sports in the menu 513 for the current season. For example, the sports widget 531 would stop showing baseball selections after baseball season is over.

FIG. 5C shows a second view of a sports widget 531 in a news mode. In some implementations, the second view of the widget 531 corresponds to the selected sport 525 from the first view of the widget 503. When in news mode, the second view of the sports widget 531 displays news headlines 547 related to the specific sport 525. A news button 537 is highlighted when the second view of the sports widget 531 is in news mode. Other buttons that indicate other modes, such as a scores button 543 that indicates a scores mode, are not highlighted at this time. The user can toggle between the modes by selecting the appropriate button 537, 543. If there are more headlines 547 than can be displayed by the widget, a scrolling bar 551 is provided to allow the user to scroll through the headlines 547. Alternatively, the headlines 547 can scroll up, down or across the screen.

The computer receives the news and scores from a source of sports information (e.g., ESPN®, CBS SportsLine®, etc.). For example, the sports information can be provided by a Real Simple Syndication (RSS) news feed streamed from a source's website, as described in the publicly available RSS and Atom formats (e.g., RSS 0.9, RSS 1.0, RSS 2.0, Atom 0.3, and any other subsequent versions). In some implementations, the user's computer can include a news reader for aggregating and viewing RSS feeds from multiple sources for display by the sport widget 531. The news reader can periodically retrieve updates to the news feed of each source. News reader programs are publicly available for free or for a subscription fee, and can be downloaded and installed onto the user's computer. Some of the more popular news readers that are publicly available include Safari® RSS, NetNewsWire®, Yahoo® RSS, and Google® RSS.

In some implementations, the headlines 547 are updated within the second view of the widget 531 when the widget is open. The updated headlines can be fed directly from the source to the user's computer.

In some implementations, if a user wants additional information regarding a particular headline 547, such as a full story, the user can select the headline 547. Selecting the headline 547 can cause the user's computer to retrieve the full story. The story can either be presented within the second view of the widget 531 or a web browser can be opened to one or more web sites or other news sources carrying the story.

One portion of the second view of the sports widget 531 can be devoted to an animated ticker 559 that displays current game scores and/or other sports-related information. For example, the ticker 559 can display one score, or can be animated to display multiple scores. The animation can scroll through the scores, flip the letters and numbers individually or flip the entire score up to down to display the next score. In some implementations, the content of the ticker 559 can be changed dynamically based on new or updated scores as received from one or more news sources. The ticker 559 can alternatively be displayed vertically, rather than horizontally, as shown, or multiple tickers can be displayed at the same time. In some implementations, the widget provides control mechanisms for controlling the speed of the ticker 559, the location of the ticker 559 and the content displayed by the ticker 559.

FIG. 5D shows the second view of the widget 531 in a scores mode. A scores button 543 is now highlighted to reflect the scores mode. In the scores mode, scores 561 of recent games are displayed by the widget. The scores 561 can include the players or teams, the numeric score, the stage of the game, e.g., first quarter, second period, halftime, or if the game has not started, the start time. Additional information about the game can also be displayed, such as player or team statistics, standings, etc. In some implementations, the user can choose a display format and/or location for the information from a preference pane, a menu or other selection mechanism. If there are more scores 561 than can legibly be displayed by the widget, a scrolling bar 551 or similar mechanism can be included for allowing the user to navigate through the scores. In the scores mode, the ticker 559 can display scores along the bottom of the widget. If any scores 561 are delayed (i.e., the score is not updated in real-time), the delay can be indicated as such on the widget or in the dashboard with a footnote, a marker or other indicia (e.g., a star), or the delayed scores can be presented by the widget in a different color, font or size than the current scores.

In one implementation, when the user selects one of the scores 561, the corresponding game appears in the ticker 559. If the game is “live,” that is, if the game is occurring while the widget is open, the ticker can be updated as the score and/or the period of the game changes. Alternatively, because the view is already in the scores mode, the ticker 559 can display other information, such as news headlines, team or player statistics, advertising, etc. In some implementations, when the user clicks on the ticker 559, a browser is opened and directed to website with more detailed information regarding the game that is displayed in the ticker 559. Each item that can be selected to obtain more detailed information is a subtopic of the sport that is displayed by the widget. The subtopics can includes items such as players, teams, coaches, venues or games.

FIG. 5E shows the second view of the widget 531 when the selected sport is not currently in season, or when there is no news or no scores to report. The widget can display a message 565, such as “no current news” or “no current scores” (as shown in FIG. 5F). In some implementations, the first view of the widget 503 dynamically removes sports that have no associated scores or news from the list of sports that can be selected.

In some implementations, when the game is live, the widget can indicate when an event has occurred in the game. The event, or triggering incident, can includes a scoring event, a change in player, a penalty, an end of a round, a time out, a down, or other such event. The widget can display an animation when the event occurs, such as fireworks, a flag, a colored background or other such indication that the triggering incident has occurred.

In the sports widgets shown in FIGS. 5A-5F, the information is provided by ESPN, Inc., as shown by logo 517. However, the information could be provided by any provider of sports related information (e.g., CBS SportsLine®).

When a user switches between different views of the widget, such as when the user proceeds from the first view of the widget 503 to the second view 531, the widget can appear to rotate, incrementally morph, or otherwise change according to a selected animation. Additionally, the widgets can have a background or overall theme that corresponds to the sport displayed by the widget. A basketball widget can display a background of a basketball, a court, a hoop or a scoreboard. A tennis widget can display a background of a net, a tennis ball, a racket or other tennis related image. Other sports widgets can similarly have a background or theme that corresponds to the particular sport that is being displayed. The theme can be the overall look and feel of the widget, for example, in scores mode, the widget can look like a scoreboard for the selected sport. Special events, such as the World Cup, the Olympics, Wimbledon, the Rose Bowl, the World Series, or other such events can also be indicated as impending or currently taking place by the theme of the widget. New artwork can be downloaded for the widget and the widget can modify itself according to the season or special events that are occurring.

Audio sounds can be included in the widget. In the news mode, a user can select a link within the widget to a sound bite or speech from a player or coach. In the scores mode, an audio clip, such as of a crowd cheering, a buzzer, an organ playing or a sound clip form a song as frequently heard at live sporting events, can play when a triggering incident occurs.

In some implementations, the widget includes a link to a video clip. When the user selects the link, a video clip, such as a highlight from a game or an interview with a player, can be displayed in the widget or on a separate web page. The widget can also include other types of links, such as links to a chat room or blog devoted to the widget topic or to a specific subtopic of the widget, such as a particular player, team or championship tournament that is associated with the sport.

In some implementations, the widget includes a search input (not shown). The user can type in a search for a sporting event or sports news related item. A web site with information about the user's search request can be opened in response to the input.

In some implementations, the widget can be programmed for sharing with a predetermined group of users. The users in the group can select information that they are most interested in being displayed on the widget. For example, the group may participate in a fantasy sporting league. Each member can input their choices for their fantasy team. One of the member's computers or a remote server can track the users' selections, such as points allocated to a game or the members of a fantasy team. Statistics related to each user's selection are then retrieved and stored. The statistics can then be displayed in the widget on command. The information can be viewed by any member of the predetermined group. The information can be tracked, calculated and stored over a “season” for the fantasy sporting league.

While widgets directed to sports news and information have been described herein, similar widgets could be used to describe any type of news item, including world affairs, local news, celebrity and entertainment news or stock market news.

It will be understood by those skilled in the relevant art that the above-described implementations are merely exemplary, and many changes can be made without departing from the true spirit and scope of the present invention. Therefore, it is intended by the appended claims to cover all such changes and modifications that come within the true spirit and scope of this invention.

What is claimed is:

1. A method of presenting sports-related information, comprising:
displaying a dashboard layer including a sports-related widget;
receiving a sport selection;
aggregating information relating to the selected sport from one or more information sources; and
configuring the widget to display at least some aggregated information.

2. The method of claim 1, wherein configuring the widget to display at least some aggregated information includes displaying at least one of news or scores related to the selected sport.

3. The method of claim 1, wherein configuring the widget to display at least some aggregated information includes displaying a first view of the widget and a second view of the widget, wherein the first view of the widget presents a mechanism for selecting a sport from a plurality of sports, and the second view of the widget presents information or scores for the selected sport.

4. The method of claim 3, wherein the plurality of sports is determined base on the current season.

5. The method of claim 3, wherein displaying the first view of the widget and the second view of the widget includes an animated transition between the first view and the second view.

6. The method of claim 5, wherein the transition includes animating the widget so that it appears to be turning or flipping to display the second view.

7. The method of claim 1, wherein configuring the widget to display at least some aggregated information includes displaying the widget with theme elements that corresponds to the selected sport.

8. The method of claim 1, wherein configuring the widget to display at least some aggregated information includes displaying text related to the selected sport, the text including a link configured for providing additional information when selected.

9. The method of claim 1, further comprising displaying a graphic on the widget that indicates that a triggering incident has occurred.

10. The method of claim 9, wherein displaying a graphic includes displaying a graphic indicating that the triggering incident is one of a breaking headline, a scoring event, an end of a portion of a game or a penalizing event.

11. The method of claim 1, further comprising:
receiving user input;
in response to receiving the user input, sending a request to access a web site with a topic corresponding to the sport that is displayed by the widget or that is specific to a subtopic of the sport displayed by the widget.

12. The method of claim 1, wherein configuring the widget to display at least some aggregated information includes displaying a message indicating that no information is available for the sport.

13. A sports-related widget configurable for display in a dashboard layer, comprising:
an selection mechanism for receiving a sport selection;
an aggregator adapted for aggregating information relating to the selected sport from one or more information sources; and
a display area adapted for displaying at least some aggregated information.

14. A system for presenting sports-related information, comprising:
a processor; and
a computer-readable medium coupled to the processor, and including instructions, which when executed by the processor, causes the processor to perform the operations of:
displaying a dashboard layer including a sports-related widget;
receiving a sport selection;
aggregating information relating to the selected sport from one or more information sources; and
configuring the widget to display at least some aggregated information.

15. A computer-readable medium including instructions, which when executed by a processor, causes the processor to perform the operations of:
displaying a dashboard layer including a sports-related widget;
receiving a sport selection;
aggregating information relating to the selected sport from one or more information sources; and
configuring the widget to display at least some aggregated information.

16. The computer-readable medium of claim 15, wherein configuring the widget to display at least some aggregated information includes providing an animated graphic simulating a ticker tape for displaying at least some of the aggregated information.

17. The computer-readable medium of claim 15, wherein configuring the widget to display at least some aggregated information includes displaying at least one of news or scores related to the selected sport.

18. The computer-readable medium of claim 15, wherein configuring the widget to display at least some aggregated information includes displaying a first view of the widget and a second view of the widget, wherein the first view of the widget presents a mechanism for selecting a sport from a plurality of sports, and the second view of the widget presents information or scores for the selected sport.

19. The computer-readable medium of claim 18, wherein the plurality of sports is determined base on the current season.

20. The computer-readable medium of claim 18, wherein displaying the first view of the widget and the second view of the widget includes an animated transition between the first view and the second view.
